(19) United States
(12) Patent Application Publication
(10) Pub. No.: US 2003/0029802 A1
(43) Pub. Date: Feb. 13, 2003

(54) Hydrocarbon absorbent polymer & method of use

(76) Inventor: Juan Ruiz, Corpus Christi, TX (US)

Correspondence Address: William P. Glenn, Jr., Suite 205, 2102 Mechanic Street, Galveston, TX, 77550, US

(21) Appl. No.: 10/217,007

(22) Filed: Aug. 12, 2002

Related U.S. Application Data
(60) Provisional application No. 60/311,917, filed on Aug. 13, 2001.

(51) Int. Cl. C02F 1/28

(52) U.S. Cl. 210/693

(57) ABSTRACT

A process and kit to create a spongy polyamide material that absorbs hydrocarbons from liquid or solid surfaces is described. The process for making the spongy polyamide material includes dissolving a polyamide in a solvent, introducing a non-solvent into the polyamide solvent solution to precipitate a spongy polyamide material and thereafter formed into different shapes, if so desired. The kit allows for the spongy polyamide material to be made at the site of an hydrocarbon spill. In one embodiment, the kit includes a premixed polyamide and solvent solution for use with water to precipitate a spongy polyamide material to be extruded and cut into a user desired form.

### RELATED PATENT APPLICATIONS

This patent application claims priority to U.S. Provisional Application No. 60/311917 filed Aug. 13, 2001 entitled “Oil Absorbent Polymer and Method of Use.”

### DESCRIPTION

### BACKGROUND OF THE INVENTION

This invention relates to polymers that can be used to absorb hydrocarbons and processes for making and using the polymers to absorb hydrocarbon. More specifically, this invention relates to the production and use of hydrocarbon absorbent nylon.

Removing spilled hydrocarbons has been and is a challenging task. In particular, cleaning up hydrocarbon spills is a challenge, particularly when the hydrocarbon is free to spread out over a surface. In the marine environment, hydrocarbon can be skimmed from the water surface, but not very efficiently. Chemical dispersants can be used to clean up hydrocarbon spills, but they are potentially harmful to the environment. Likewise, in situ burning can be used to clean up hydrocarbon spills, but again with potential harm to the environment.

Presently, the most common cleanup method is to introduce hydrocarbon absorbent material into the spill area. One approach teaches the production and use of water excluding materials to more selectively absorb the hydrocarbon, like U.S. Pat. No. 3,990,970 issued to Porte (Porte '970). More specifically, the Porte '970 reference discloses an hydrocarbon absorbent product created by dissolving polymers in a solvent, precipitating the dissolved polymers with a non-solvent, rinsing, and drying them. The Porte '970 reference requires the time consuming step of drying the hydrocarbon absorbent product. Furthermore, in the most preferred embodiment, the hydrocarbon absorbent material is coated with a water-repellant and oleophilic material before use. The Porte '970 hydrocarbon absorbent product is limited to the absorption of hydrocarbon from water surfaces.

U.S. Pat. No. 3,764,527 to Sohl (Sohl '527) describes a method of removing hydrocarbons from an hydrocarbon and water mixture using a web of oleophilic polymeric fibers. The Sohl '527 reference teaches only one time use of the web, which requires a number of webs to be on hand during hydrocarbon spill operations. Such a procedure further increases the amount of spent materials to be disposed of upon completion of the clean up operations.

U.S. Pat. No. 3,700,593 to Bezemer (Bezemer '593) discloses an apparatus for removing hydrocarbon from a water surface including an hydrocarbon absorbent porous body made from an organic polymer. The Bezemer '593 reference is limited to use between two bodies such as 2 boats or a boat and a base structure. This feature may delay the commencement of hydrocarbon recovery if a second or base structure is not readily available. To extend the life of the porous body, the Bezemer '593 reference warns against squeezing to extract absorbed hydrocarbon.

Another approach for removing hydrocarbon from the surface of water is described in U.S. Pat. No. 3,536,616 to Kondoh (Kondoh '616). A polymer is dissolved in a low-hydrocarboning point organic solvent, sprayed on the hydrocarbon water mixture where the solvent evaporates and leaves a film or droplets of polymer that absorb hydrocarbons. The Kondoh '616 reference limits retrieval of the film or droplets and hydrocarbon by nets or similar means. The Kondoh '616 reference lacks a means for containing the spill or retrieval of the film or droplets and hydrocarbon in rough water conditions.

The invention disclosed in the following sections eliminates or reduces the limitations discussed above. The present invention provides a new and novel method for producing an hydrocarbon absorbent polymer which can be reused many times. The invention further provides the advantage of being extremely portable, as it can be created on-site from a kit. Finally, the hydrocarbon absorbent polymer can be produced to absorb as well as contain a spill.

### SUMMARY OF THE INVENTION

The present invention introduces an hydrocarbon absorbent polyamide material, a method for making the polyamide material, and a method of using the polyamide material. The polyamide material is made by dissolving a polymer in a solvent, creating a solution which is added to a non-solvent for the polymer in which the solvent is soluble. In one embodiment, non-solvent is streamed into the resulting solution, and a spongy, hydrocarbon absorbent material precipitates. The material is rinsed and ready for use as an hydrocarbon absorbent with or without drying.

One object of the invention is to present a polyamide material that absorbs hydrocarbons as well as, or better than existing materials and at a rapid rate. Another object of the invention is to provide a use for waste or recycled nylon. A further object of this intention is to use a safe, inexpensive non-solvent, such as water. The hydrocarbon absorbent polyamide material can be used without drying, which allows for faster production and use (than comparable products) when spilled hydrocarbon must be removed as quickly as possible. Another object of the invention is to provide a simple, efficient on-site process to create an hydrocarbon absorbing material with the appropriate shape to absorb hydrocarbon.

### BRIEF DESCRIPTION OF THE DRAWINGS

FIGS. 1a, b & c depict a process of making a hydrocarbon absorbent polyamide.

FIGS. 2 through 10 depict flowing and injecting of a polyamide formic acid solution into water.

### DETAILED DESCRIPTION OF THE INVENTION

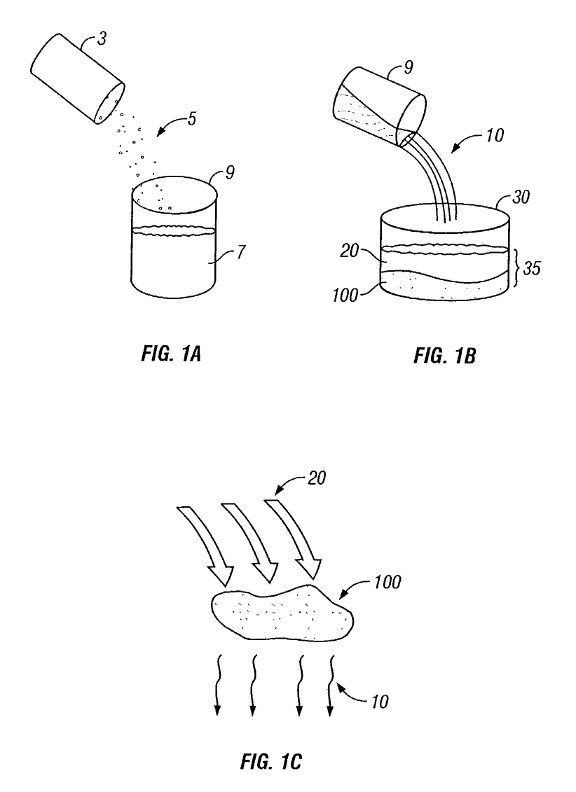

A new hydrocarbon absorbent polyamide material 05 made with the goal of using existing resources more efficiently in its production and use than hydrocarbon absorbing materials or methods currently available. As generally shown in FIGS. 1a-c, the process of making an hydrocarbon absorbent polyamide spongy material 100 comprises the steps of dissolving a predetermined quantity of polyamide material 05, like nylon, in a predetermined quantity of formic acid 07 to form a solution 10. (FIG. 1a) The solution 10 is introduced into a container or mixing vessel 30 capable of holding a predetermined quantity of water 20 sufficient to cause a precipitation of a spongy material 100 capable of absorbing hydrocarbons. (FIG. 1b) In one embodiment, the water 20 is at ambient temperature. Then formic acid 07 and water 20 are removed from a spongy material 100. In one embodiment, a spongy material 100 is rinsed with additional water 20 to neutralize and remove residual solution 10. (FIG. 1c) In another embodiment, a spongy material 100 is further dried. Whether un-rinsed, rinsed, dried or un-dried, a spongy material 100 produced by the above described process is placed adjacent to a hydrocarbon spill to encourage absorption of the spill by the spongy material 100.

In another embodiment, the process includes the step of forming a spongy material 100 by encouraging said precipitation to occur in the lower region of the container 35, thereby encouraging a spongy material 100 to take the form of a substantial portion of the container's 35 lower region. (FIG. 1b) In yet another embodiment, the process includes the step of forming a spongy material 100 into flakes by applying pressure to a spongy material 100 during precipitation (not shown). The pressure can be applied directly or indirectly to a spongy material 100 immediately after precipitation. In another embodiment, the process includes the step of grinding or cutting a spongy material 100 into a granular form that encourages hydrocarbon absorption (not shown).

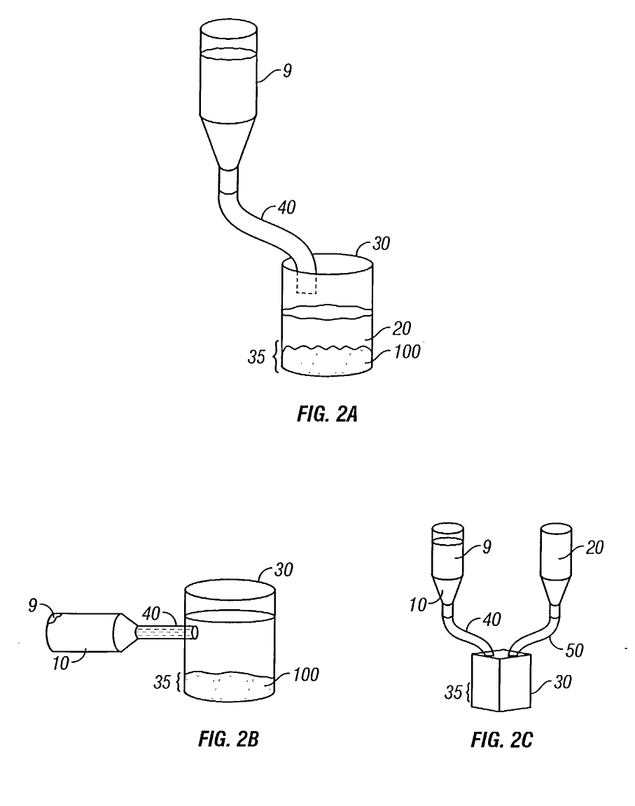

In one embodiment, the polyamide material 05 to be dissolved can be of a homogeneous or heterogeneous mixture of unfilled pellets, off source or waste nylon, or unused nylon. In a preferred embodiment of the invention, polyamide material 05 is dissolved in a solvent that includes 95% formic acid 07. The ratio of polyamide material 05 to formic acid 07 can range from 1:3 to 1:1. Mechanical stirring of the formic acid 07 and polyamide material 05 can be achieved by a stirring rod, agitation or magnetic stir bar (not shown). The polyamide material 05 can be mechanically stirred into a solution and then injected into a container 30 of anti-solvent that includes water 20. (FIGS. 2a, 2b) In one embodiment, water 20 is also streamed into a container 30 by means such as tubing 50. (FIG. 2c) After exposure to a stream or volume of water 20, the polyamide 05 precipitates out of this mixture as a spongy, porous material 100 that is many times the volume of the starting polyamide material 05. The spongy material 100 may also be used without being rinsed because there is very little formic acid 07 or solution 10 residue in or on a spongy material 100 when precipitation occurs. In an alternative embodiment, the spongy material 100 may be dried by squeezing out the water 20 and/or placed in a vacuum oven (not shown). The use of a vacuum oven (not shown) encourages an expansion of the spongy material 100. Once the formic acid 07 has been neutralized, a spongy material 100 can be immediately applied to an hydrocarbon spill to begin absorbing hydrocarbons. Types of hydrocarbons that may be absorbed include light crude oil, medium weight pump oil, dark heavy crude oil, and oil similar to diesel. It is envisioned that other hydrocarbons will be absorbed as well.

After a spongy material 100 has absorbed hydrocarbons, it may be squeezed by hand or other means to release the hydrocarbons and allow the material 100 to be used for up to 20 rounds of absorption.

This process for the production of an hydrocarbon absorbent polyamide material 100 has a low production cost and can use either virgin or existing polyamide materials 05, such as nylon. Different types of nylon can be mixed and used together, allowing for the production of the polyamide material 05 from various scraps of different nylons. In other words, a large, homogeneous supply of nylon is not required. The spongy, porous nature of the material 100 results in a light weight that makes the material 100 easy to transport and introduce to a spill. The polyamide material 100 can absorb hydrocarbons 8 times faster than a peat based hydrocarbons absorbent.

In one preferred process, 20 grams of unfilled nylon pellets 05 are dissolved in 60 milliliters of 88% formic acid 07 in a flask 30 on a shaker (not shown) for 2 hours. Stirring or agitation of the nylon 05 and formic acid 07 mixture accelerates dissolving of the nylon 05. The solution 10 is then injected into a water 20 filled beaker 30 at a temperature of 10-15° C. The injected solution 10 turns into a spongy material 100 at the bottom of the beaker 35. The water 20 is then poured out of the beaker 35 and the material 100 is rinsed several times with about one gallon of water 20. The material 100 may be squeezed to remove water 20 and further dried in a vacuum oven (not shown) at 150° for 2 hours. The absorbent polyamide material 100 produced can absorb approximately 5.4 times its weight of light crude oil, or approximately 10.1 times its weight of medium weight pump oil, or approximately 6.4 times its weight of dark heavy crude oil.

In cleaning up hydrocarbon spills, it is desirable to use an hydrocarbon absorbent polyamide material 100 that is in a shape which encourages absorption of spilled hydrocarbons. Sometimes the proper shape is not known until the spill occurs and the situation is assessed by the cleanup organization. If a traditional hydrocarbon absorbent material cannot be shaped is used, then large amounts may be required to cover the spill. For example, in order to cover small area of spilled hydrocarbons, a large piece of traditional preformed absorbent would be required, and much of it would be wasted. In the case of an hydrocarbon spill in a marine environment, the extra absorbent may perturb a previously undisturbed area. A hydrocarbon absorbent polyamide material 100 can be formed in a shape which encourages absorption by injecting a solution 10 having a dissolved polyamide 05 (like nylon) into a container 30 that has the proper shape for the type of hydrocarbon spill encountered. In one embodiment, the lower portion 35 of the container 30 is configured to form a spongy polyamide 100 material exhibits the proper shape when removed from the container 30. For example, if a rectangular shaped absorbent is determined to be the appropriate shape, then a rectangular container 30 can be used. By adding sufficient solution 10 to cover the rectangular lower region 35 of the container 35, a rectangular hydrocarbon absorbent spongy material 100 will be created. The ability to use a shaped spongy material 100 is also useful in cleaning up hydrocarbon spills which have a known and fairly static size/shape. By using an hydrocarbon absorbent polyamide material 100 of a shape that approximates the shape of the hydrocarbon spill, the minimum amount of hydrocarbon absorbent polyamide material 100 necessary to absorb the hydrocarbon may be used. Hydrocarbon spill situations in which the hydrocarbon spill has a fairly static shape include situations in which the hydrocarbon spill is contained or the hydrocarbon is prevented from spreading because of physical or environmental barriers.

The spongy material 100 can also be shaped into forms such as granules and flakes by using an amount of solution 10 that is not sufficient to cover the lower region 35 of the container 30. Small peaks of spongy material 100 will precipitate out of solution on the lower region 35 of the container 30. If pressure is applied to a spongy material 100 while precipitating, a spongy material 100 can be shaped into granules or flakes.

Another way to shape the hydrocarbon absorbent spongy material 100 is by cutting or grinding it after it has been formed. This step may aid in customizing the shape of the spongy material 100 for a shape that increases a spongy material 100 surface area, and thus accelerating the rate of hydrocarbon absorption.

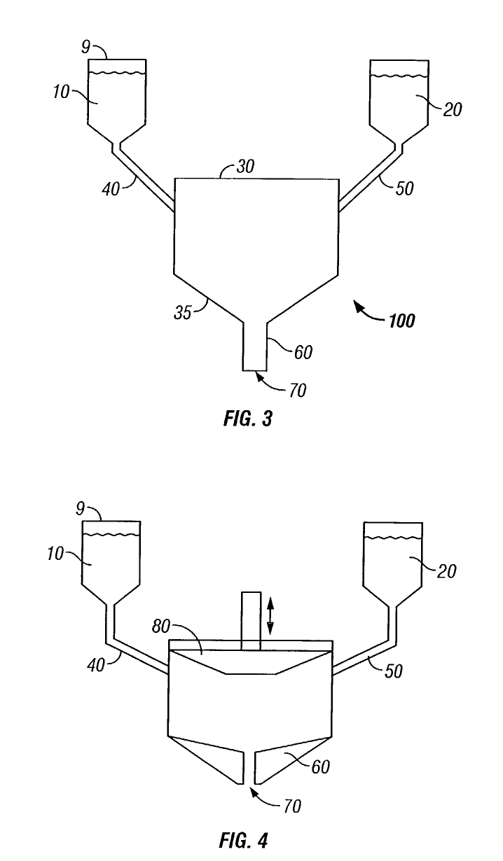

The hydrocarbon absorbent spongy material 100 is lightweight and compressible, which facilitates its transportation to an hydrocarbon spill site. It can be made even more transportable by making it on-site from a kit 110. (FIGS. 2a-c thru 6) The kit 110 includes a source of polyamide material 05 dissolved in a formic acid 07 solution, a source of water 25, a mixing vessel 30 and a tube 40 connecting the source of polyamide material 05 dissolved in a solution 10 comprising of formic acid 07 to a mixing vessel 30. (FIGS. 2a, 3, 4, 5, & 6) In one embodiment, the polyamide material 05 is pre-mixed and dissolved in formic acid 07 in a ratio of one part polyamide material 05 to a range of one to three parts formic acid 07. The solution 10 is fluidly connected to the mixing vessel 30 by a tube 40 which can be controlled by a valve, tube inner diameter or other conventional means to control the flow (not shown) of the solution 10 into the mixing vessel 30. The mixing vessel's 30 volume and shape is configured to mix a pre-determined quantity of the solution 10 with a pre-determined quantity of water 20 from the water source 25. (FIGS. 2a, 3, 4, 5, & 6) A pre-determined amount of water 20 can be poured directly into the mixing vessel 30 or supplied as a flow into the mixing vessel 30 by a second tube 50.

In one embodiment, a mixing vessel 30 contains substantially all of the predetermined quantity of water 20, and the solution 10 is flowed into the mixing vessel 30 by a controllable tube 40 to encourage formation of a spongy material 100 at a lower region 35 of a mixing vessel 30 immediately after precipitation. (FIG. 2a) In another embodiment, a water source 25 is fluidly connected to a mixing vessel 30 by a second tube 40 thereby providing a continuous flow of water 20 into the mixing vessel 30. (FIGS. 2c, 3, 4, 5, & 6)

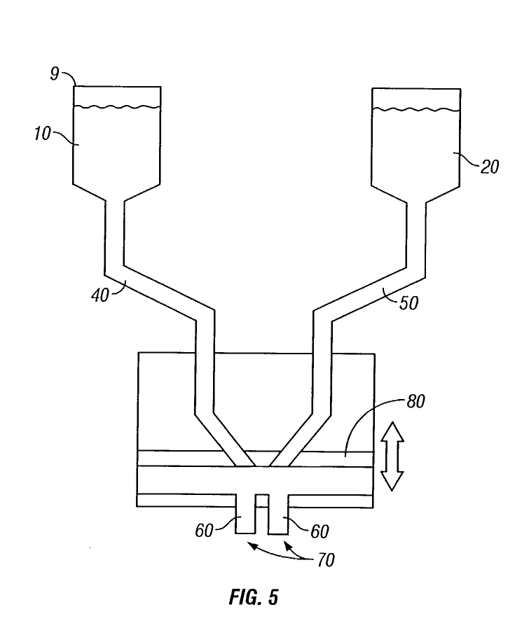

In another embodiment, a mixing vessel 30 is closeable and includes at least one extrusion passage 70 and a moveable wall 80. (FIGS. 4, 5, 6) The extrusion passage 70 extends through a wall 37 of a mixing vessel 30 and terminates with at least one exit aperture 70 located outside a mixing vessel 30. (FIGS. 4, 5, 6) By applying pressure to a solution 10 and water 20 mixture in a mixing vessel 30, a spongy material 100, which precipitates from the mixing is forced by pressure through an extrusion passage 60 and exits by traveling through an exit aperture 70. In one embodiment, an exit aperture 70 shapes an exiting spongy material 100 into a user defined shape. In another embodiment, pressure is supplied by a slideably movable wall 80 configured to vary the volume of a mixing vessel 30 (closed or otherwise). (FIGS. 4, 5, 6) In another embodiment, the first and second tubes (40, 50) are connected to a moveable wall 80 to allow introduction of solution 10 and/or water 20 into a mixing vessel 30. (FIG. 6) As can be appreciated, a moveable wall 80 allows for the volume of a mixing vessel 30 to be varied according to the amount of spongy material 100 to be produced. Likewise, a moveable wall 80 can be used to apply pressure to a spongy material 100 thereby causing movement through at least one extrusion passage 60 and at least one exit aperture 70. (FIG. 5)

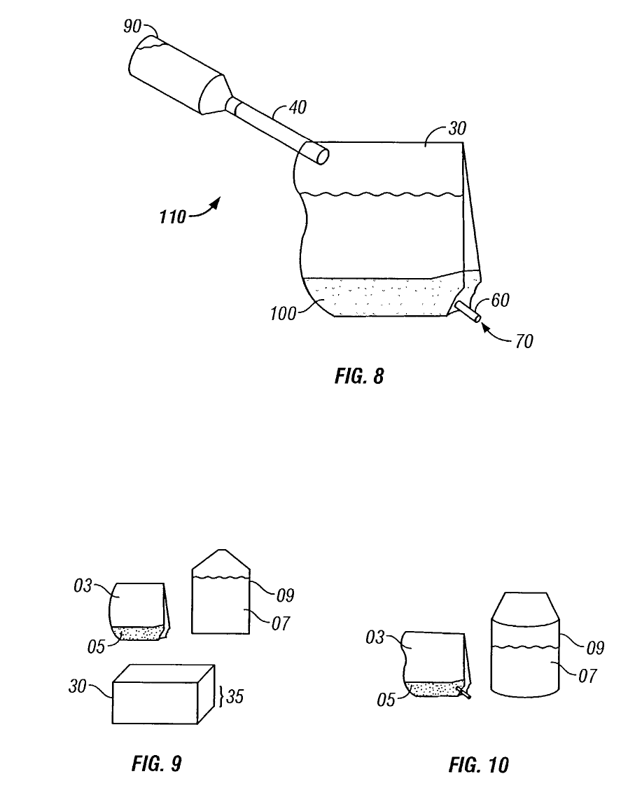

In another embodiment, a mixing vessel 30 (closed or otherwise) is pliable and configured to transmit external pressure to a spongy material 100, thereby causing a spongy material 100 to travel through an extrusion passage 60 and a exit aperture 70. A pliable mixing vessel 30 could be in the form of a bag with a resealable opening. (FIG. 8) Pressure can be applied by rolling or squeezing at least one side of a bag to encourage movement of a spongy material 100 through at least one extrusion passage 60 and at least one exit aperture 70.

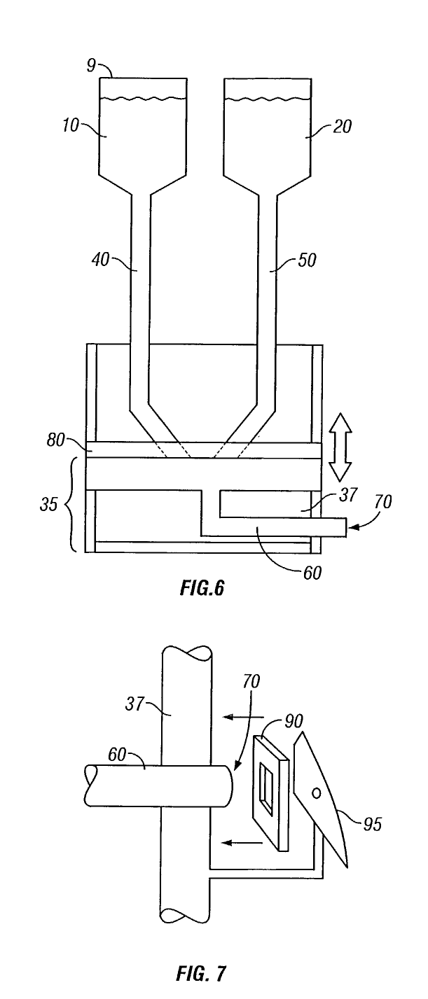

In another embodiment, at least one orifice die 90 is fixed adjacent to an exit aperture 70 to change the shape of a spongy material 100 during extrusion from a mixing vessel 30. (FIG. 7) An orifice die 90 can be removable or fixed before or after an exit aperture 70. An orifice die 90 can be configured to form a spongy material 100 with a polygonal, circular, or sheet cross sections. In yet another embodiment, a user controlled cutter 95 fixed adjacent to an extrusion passage 60 cuts a spongy material 100 to user selected lengths. (FIG. 7) A cutter 95 may be configured with an arcuate shape to produce a curved end of a formed spongy material 100. As can be appreciated, used with or without an orifice die 90, the final overall form of a spongy material 100 can be determined. For example, if an orifice die 90 with a sheet cross section is used in conjunction with a cutter 95, sheets of a spongy material 100 with varying lengths can be produced to fit the need of the user. Used with a circular cross section die 90 and an arcuate shaped cutter 95, spheres of said spongy material 100 can be formed.

In yet another embodiment, a kit 110 may include a pre-determined amount of polyamide material 05 and an pre-determined amount of formic acid 07 in separate containers 03, 09. (FIG. 9) The polyamide material 05 and formic acid 07 are combined in the formic acid container 09 or a mixing vessel 30 and stirred, or agitated, until the polyamide material 05 is dissolved in formic acid 07 and goes into solution 10. The solution 10 is then transferred into a mixing container 30 holding water 20 in which the spongy material 100 precipitates out of solution 10 near the bottom 35 of the mixing container 30. In yet another embodiment, the polyamide container 03 is sufficiently large enough to receive the solution 10 in container 09 and water 20 to cause precipitation of a spongy material 100 into container 03. (FIG. 10) When using a kit 110 on a boat, where space and weight must be conserved, the water 20 can be sea water. Finally, a spongy material 100 is removed from the mixing container 30 and is ready to be used as an hydrocarbon absorbent. It may also be used after the additional steps of being rinsed with water 20 and/or air dried. In another embodiment, a larger kit 110 containing an additional quantity of water 20 may be used. This kit 110 would be useful in situations where water 20 is not available.

Another type of kit 110 may include a premixed solution 10 of polyamide material 05 and formic acid 07 in a mixing vessel 30. Such a kit 110 may also include water 20. Using a premixed solution 10 reduces the number of storage containers 03, 09 in the kit 110. To use such a kit 110, water 20 is added to the premixed solution 10, which results in a spongy material 100 precipitating in a mixing vessel 30. The spongy material 100 is removed from the mixing vessel 30 and is ready to be used as an hydrocarbon absorbent.

In the process of using the spongy material 100 created either off-site or on-site by a kit 110, a spongy material 100 is placed on or near spilled hydrocarbons, which can be on either a liquid or solid surface. No stirring of the spongy material 100 into the hydrocarbon spill is necessary, and the spongy material 100 begins absorbing hydrocarbon immediately. The spongy material 100 remains afloat on the hydrocarbon spill even after complete saturation. The spongy material 100 is then removed from the hydrocarbon spill, squeezed by hand or mechanical means to release the absorbed hydrocarbon which can be collected into a spill container (not shown), and returned to the hydrocarbon spill for up to 20 rounds of hydrocarbon absorption.

Hydrocarbon spill situations in which the spongy material 100 can be used to remove hydrocarbons include marine hydrocarbon spills from boats or rigs and land hydrocarbon spills from vehicles, auto shops, and factories.

I claim:

1. A process of making and using an absorbent material for hydrocarbon spills comprising the steps of:
introducing a pre-determined quantity of a solution comprising a polyamide material dissolved in formic acid to a pre-determined quantity of ambient temperature water thereby resulting in the precipitation of a spongy material capable of absorbing hydrocarbons;
forming said spongy material by encouraging said precipitation to occur in a first container;
removing substantially all of said solution from said spongy material; and
deploying said spongy material adjacent to a hydrocarbon spill to encourage absorption of said spill by said spongy material.

2. The process of claim 1, further comprising the step of rinsing said spongy material with water prior to said deployment.

3. The process of claim 1, further comprising the step of drying said spongy material prior to said deployment.

4. The process of claim 1, wherein the step of forming said spongy material occurs in the lower region of said container, thereby encouraging said spongy material to take the shape of said lower region of said container.

5. The process of claim 1, wherein the step of forming said spongy material comprises a further step of applying pressure to said spongy material shortly after said precipitation thereby encouraging said spongy material to take the shape of at least one flake.

6. The process of claim 1, further comprising the step of cutting said spongy material into a shape that encourages hydrocarbon absorption.

7. The process of claim 1, further comprising the step of grinding said spongy material thereby resulting in a plurality of granules of sufficient size and shape to encourage hydrocarbon absorption in each granule.

8. The process of claim 1, wherein said polyamide material is selected from a group consisting of unfilled nylon, nylon waste material, and unused nylon.

9. The process of claim 1, wherein said solution comprises a ratio of one part said polyamide material to three parts said formic acid.

10. A kit for creating a hydrocarbon absorbing material comprising:
a source of solution which comprises a polyamide material dissolved in formic acid in a ratio of one part polyamide material to a range of one to three parts formic acid;
a source of water;
a mixing vessel configured to mix a pre-determined quantity of said solution with a pre-determined quantity of water from said source of water, and a first tube fluidly connecting said solution source to said mixing vessel, said first tube configured to allow the controlled flow of said solution into said mixing vessel.

11. A kit as described in claim 10, wherein said mixing vessel contains substantially all of said pre-determined quantity of water and said solution is flowed into said mixing vessel via said tube to encourage formation of said spongy material at a lower region of said mixing vessel immediately after said precipitation.

12. A kit as described in claim 11, wherein said water source is fluidly connected to said mixing vessel by a second tube, said mixing vessel further comprising at least one extrusion orifice and a moveable wall, said extrusion orifice extending through a wall of said mixing vessel and terminating with at least one exit aperture outside of said mixing vessel, said moveable wall is sizeably fixed to said mixing vessel to vary the volume of said mixing vessel, said spongy material is forced through said extrusion orifice by said moveably wall shortly after said precipitation and formed by said exit aperture orifice shortly after said precipitation in said mixing vessel.

13. A kit as described in claim 12, further comprising at least one orifice die removablebly fixed adjacent to said exit aperture to change the shape of said spongy material during extrusion from said mixing vessel.

14. A kit as described in claim 12, wherein a user controlled cutter fixed adjacent to said orifice cuts said spongy material to user selected lengths.
